(19) United States
(12) Patent Application Publication
(10) Pub. No.: US 2017/0334363 A1
(43) Pub. Date: Nov. 23, 2017

(54) MECHANICAL HOLDER FOR A MOBILE DEVICE ON BOARD A VEHICLE

(71) Applicants: CONTINENTAL AUTOMOTIVE FRANCE, Toulouse (FR); CONTINENTAL AUTOMOTIVE GmbH, Hannover (DE)

(72) Inventor: Jean-Philippe BEKAERT, Montigny Le Bretonneux (FR)

(21) Appl. No.: 15/520,865

(22) PCT Filed: Oct. 19, 2015
(86) PCT No.: PCT/EP2015/002066

§ 371 Date: Apr. 21, 2017

(30) Foreign Application Priority Data
Oct. 23, 2014 (FR) 1460190

(51) Int. Cl. B60R 11/02; B60R 7/08; B60R 11/00

(52) U.S. Cl. CPC B60R 11/0241; B60R 7/08; B60R 2011/0071; B60R 2011/0003; B60R 2011/0094; B60R 2011/0045

(57) ABSTRACT

Disclosed is a mechanical holder for a mobile device on board a vehicle, including two jaws that are rotatably hinged about an axis and close on the mobile device, the closing movement of the two jaws being such that, regardless of the mobile device engageable with the mechanical holder, the position of the mobile device is identical. The two jaws each have a gear wheel secured thereto, wherein the gear wheel is mounted on an axis parallel to the axis of rotation of the jaws and engages with the other wheel to form a gearing and to allow each jaw to rotate simultaneously and identically relative to the axes of rotation of the respective gear wheels thereof.

The present invention relates to a mechanical holder for a mobile device on board a vehicle.

Currently, many devices are mobile (GPS, telephones, personal assistants, etc.) and interact with the on-board devices of motor vehicles.

Thus, many people enter the vehicle listening, for example, to music on their mobile device and wish to be able to continue listening once inside the vehicle. The majority of modern vehicles are thus equipped with means for recognizing and communicating with said mobile devices in order to offer this possibility for continuous and extensive use.

It is thus necessary to place these mobile devices on a holder or in a housing when entering the vehicle, in order to have said devices to hand and/or in the field of vision and thus to be able to intact therewith via their human/machine interface or to make use of the information which they provide.

A wide variety of devices have thus been developed in order to permit the fixing of such devices at various locations in the vehicle.

These devices are frequently provided with suction cup fixing systems, for example a system for fixing the mobile device onto or into a holder and means for the orientation of the holder/mobile device assembly along several axes in order to present the visual information for the user in an optimum manner.

Apart from the fact that the suction cup fixing systems are often poorly installed and inefficient and occasionally lead to the holder and the mobile device falling off, these devices have the major drawback of not being practical in use, in terms of their positioning, since they have to be adjusted for each mobile appliance placed on the holder.

Moreover, the greater the number of adjustments provided (degrees of freedom) of the relative position of the mobile device with regard to the user, the more complicated the handling of the device. This leads to a large number of clamping and releasing movements which are rather awkward and ultimately are disrupted with the vibrations occurring during the movements of the motor vehicle.

The object of the invention is thus to propose a solution which is simple and reliable, permitting a mobile device to be held in a vehicle.

In order to achieve this, the invention proposes a mechanical holder for a mobile device on board a vehicle, comprising two jaws which are rotatably hinged about an axis and which close on said mobile device, the closing kinematics of said two jaws being such that, regardless of the mobile device which is able to cooperate with said mechanical holder, the position of said mobile device is identical, and the holder being noteworthy in that the two jaws each have a gear wheel which is secured thereto and which is mounted on an axis parallel to the axis of rotation of the jaws, said gear wheels cooperating with one another to form a gearing and to allow each jaw to rotate simultaneously and identically relative to the axis of rotation of the respective gear wheel thereof.

In particular embodiments, the invention may comprise one or more of the following features, which may be considered individually or according to any technically effective combination. Thus at least one of the jaws is provided with at least one stop, making it possible to prevent the mobile device from moving back when bearing against said mobile device during the use thereof. Advantageously, the stops are positioned in a staggered manner so as not to oppose the opening and closing kinematics of the two jaws.

The invention will be understood more clearly from reading the following description. This is purely by way of illustration and has to be read with reference to the accompanying drawings, in which:

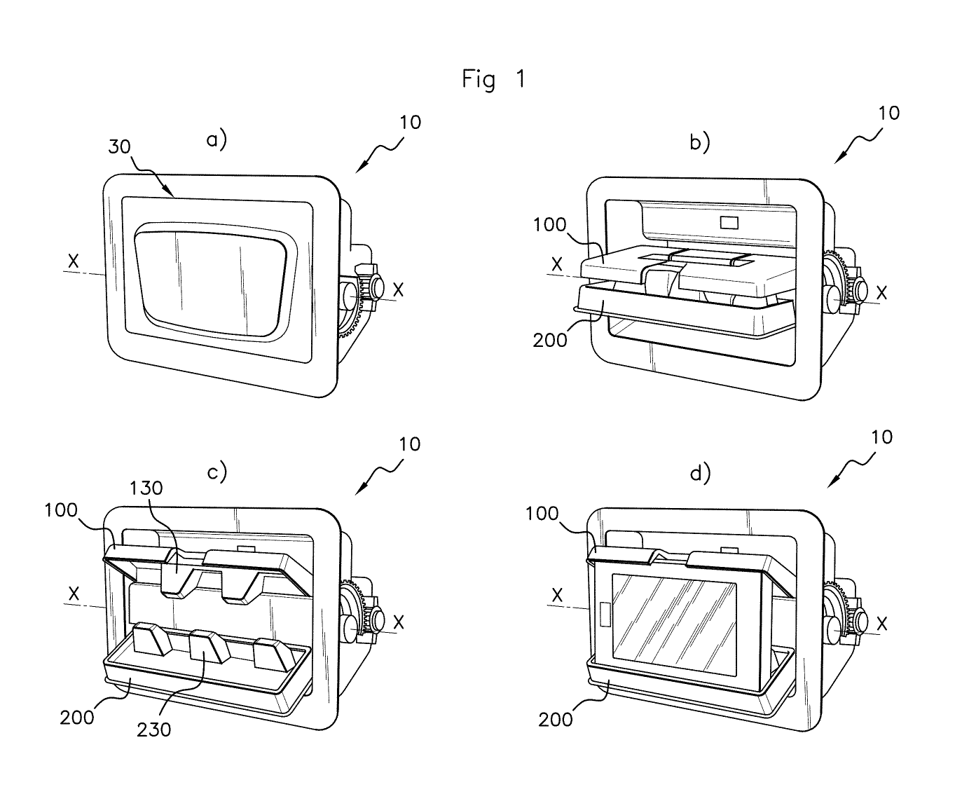

FIG. 1 shows a three-dimensional view of a holder according to the invention in various positions referenced a), b), c) and d),

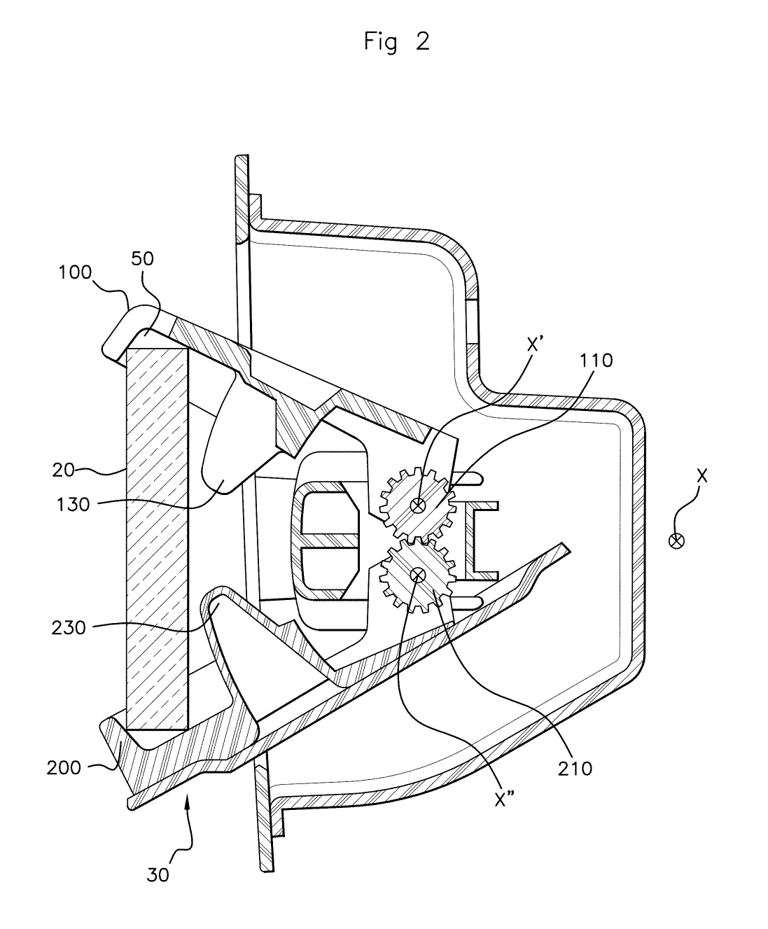

FIG. 2 is a partial sectional view of a holder according to the invention provided with a system for the engagement of the jaws.

It should be mentioned that the figures disclose the invention in a detailed manner for implementing the invention, said figures naturally being able to be used to define the invention more clearly if required.

In the description, the same reference numerals denote identical or functionally equivalent elements, from one figure to the next.

FIG. 1 shows a mechanical holder 10 according to the invention and illustrated in the form of an assembly which is able to be integrated in the instrument panel of the motor vehicle (not shown) which receives said assembly. This does not in any way limit the scope of the invention, said invention certainly being able to be presented in the form of an assembly to be fixed externally to the instrument panel or a different location of the vehicle.

The mechanical holder 10 is shown in various positions:
a first view in FIG. 1a) in which the mechanical holder 10 is retracted into the receiving housing, thus having no more than one facade 30 toward the outside, said facade being incorporated in the overall appearance of the instrument panel. According to this embodiment, therefore, an unattractive protuberance is not present, as is often the case with apparatuses for fixing mobile devices which are added onto the instrument panel or the windshield of the vehicle.
in FIG. 1b) the mechanical holder is deployed and is waiting to be implemented. Here the two jaws 100, 200 are seen. This position may be obtained by means of a rotation of the facade 30 which, in this particular example, constitutes the underside of the jaw 200.
in FIG. 1c) the jaws 100, 200 are open and ready to receive the mobile device 20 which in this case is a portable telephone (also called a “smartphone”).
finally FIG. 1d) shows the mechanical holder 10 receiving the portable telephone.

FIG. 2 is a partial sectional view of an embodiment of the invention comprising a gearing consisting of two gear wheels 110, 210 respectively mounted fixedly on two axes X′, X″ which are parallel to one another. This embodiment has the advantage of mechanically linking the movements of the two jaws 100, 200 according to specific and fixed kinematics.

Thus, there is no risk of one of the two jaws 100, 200 being displaced more rapidly than the other when the mobile device 20 is locked in position in the housings 50 provided to this end. As the opening kinematics are controlled, regardless of the mobile device 20 inserted, its position is always the same. This naturally applies to mobile devices 20 which are compatible with the dimensions able to be accepted by the mechanical holder.

By “controlled opening kinematics” it is understood in our embodiment that the movements of the jaws 100, 200 are synchronous. As a result, a normal relative to the screen of the mobile device 20 always merges with the bisector of the angle formed by the two jaws 100, 200. The result of this feature is to guarantee a uniform viewing angle and more comfortable use of the mobile device 20. More specifically, a motor vehicle manufacturer incorporates the ideal positions of the screens and human/machine interfaces at the design stage of the motor vehicle. A mechanical holder 10 according to the invention makes it possible to guarantee that the positions provided are properly adhered to, whatever the type of mobile device 20 being placed in said mechanical holder.

A further advantage of a mechanical holder 10 as disclosed above is that it is easy to handle since it now suffices for the user to displace one of the jaws 100, 200 so that the other is displaced in an identical manner. It might even be conceivable to introduce the mobile device 20 using one hand, since it suffices to place said mobile device on the edge of the lower jaw 200 and to displace said jaw downwardly. The upper jaw 100 is thus opened accordingly and the mobile device is released into the housing 50 when the space opened up by the synchronous separation of the jaws 100, 200 is sufficient.

The stops 130, 230 have several functions, including in particular the following. They permit easy positioning of the mobile device 20 which has been placed thereon when introduced, just before closing the jaws 100, 200 on the mobile device 20. Said mobile device is then positioned in the housings 50 and no longer has to be in contact with the stops 130, 230. More specifically, the contact depends on the overall space requirement of the mobile device 20.

These stops 130, 230 also permit the positioning of the mobile device 20 to be secured in the case of an unexpected movement of the user; the mobile device is thus prevented from moving back and is not at risk of jamming in the mechanical holder 10 in the case of impact, for example. A mechanical stop is thus provided in all directions and the mobile device 20 is held fixedly, in contrast to apparatuses of the prior art, many of which do not guarantee this retention in a plurality of directions.

In the case of a potential accident occurring when the mechanical holder 10 according to the invention is in use, its rounded shape prevents any injury when coming into contact with a part of the body striking it. This is a safety requirement which is taken into account in the design of motor vehicles and which is guaranteed here. Moreover, as the mechanical holder encompasses the majority of the mobile device 20, even if said device is provided with sharp or pointed edges, the edges are protected and do not risk causing injury.

1. A mechanical holder (10) for a mobile device (20) on board a vehicle, comprising two jaws (100, 200) which are rotatably hinged about an axis (X) and which close on said mobile device (20), the closing kinematics of said two jaws (100, 200) being such that, regardless of the mobile device (20) which is able to cooperate with said mechanical holder (10), the position of said mobile device (20) is identical, characterized in that the two jaws (100, 200) each have a gear wheel (110, 210) which is secured thereto and which is mounted on an axis (X′, X″) parallel to the axis (X) of rotation of the jaws (100, 200), said gear wheels cooperating with one another to form a gearing and to allow each jaw (100, 200) to rotate simultaneously and identically relative to the axis of rotation (X′, X″) of the respective gear wheel (110, 210) thereof.

2. The mechanical holder (10) as claimed in claim 1, wherein at least one of the jaws (100, 200) is provided with at least one stop (130, 230), making it possible to prevent the mobile device (20) from moving back when bearing against said mobile device (20) during the use thereof.

3. The mechanical holder (10) as claimed in claim 2, wherein the stops (130, 230) are positioned in a staggered manner so as not to oppose the opening and closing kinematics of the two jaws (100, 200).
